(19) United States
(12) Patent Application Publication
(10) Pub. No.: US 2009/0181213 A1
(43) Pub. Date: Jul. 16, 2009

(54) Method And Apparatus For Manufacturing A Retroflective Device

(75) Inventors: Ian I. Durant, Lancashire (GB); Richard H. Hughes, Northwich (GB)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: Prismo Limited, Hartford (GB)

(21) Appl. No.: 12/409,293

(22) Filed: Mar. 23, 2009

Related U.S. Application Data
(63) Continuation of application No. 10/866,599, filed on Jun. 10, 2004.
(60) Provisional application No. 60/477,712, filed on Jun. 11, 2003.

(51) Int. Cl. E01F 9/04; B29C 67/02; C09D 5/00

(52) U.S. Cl. 428/143; 264/117; 106/31.04

(57) ABSTRACT

The present application relates to a method and apparatus for manufacturing an agglomeration of glass beads consisting of a plurality of glass beads bound together by means of a binder material. An apparatus is described which includes a dispensing device (3a; 3b; 3c) having a plurality of channels (5) along which, in use, binder material flows. Each of the channels terminates in an outlet (8) and is in fluid communications with a single binder inlet (6). Importantly, the channels are of substantially identical length and diameter. One or more dispensing devices may be coupled to a single distribution unit (2)

### CROSS-REFERENCE TO RELATED APPLICATION

This application is a continuation of U.S. patent application Ser. No. 10/866,599 filed Jun. 10, 2004 which claims the benefit of the filing date of U.S. Provisional Application No. 60/477,712 filed Jun. 11, 2003.

### FIELD OF THE INVENTION

The present invention relates to a method and apparatus for manufacturing an agglomeration of glass beads. In particular, the present invention relates to method and apparatus for manufacturing an agglomeration of glass beads for use as a retroreflective device. Such a device may be used to create retroreflective surfaces, for example reflective markings and delineators, and high visibility coatings having reflective characteristics. The present invention finds particular use on roads and road signs.

### BACKGROUND OF THE INVENTION

Markings for highway (road) marking are usually required to be reflective at night. Light emitted from vehicle headlights is reflected back in the direction of the source, i.e. retroreflected, from the surface of the marking or other reflective surface. The retroreflective characteristic of the marking material is typically improved by use of added retroreflective elements or devices. In road markings, spherical glass beads are often added to the surface of the marking during application, or sometimes premised in the body of the marking material, and by this means the retroreflective characteristics are significantly improved over the natural reflective property of the marking surface. However, road markings are usually applied in locations likely to be exposed to traffic, i.e. contacted by vehicle wheels, and such contact leads to deterioration, through abrasion and other effects, of the reflective material, thereby reducing its retroreflective properties.

Spherical glass beads have also been used to form a retroreflective element that consists of a plurality of glass beads disposed about a central core material. However, the retroreflective properties of such device will be lost should the glass beads become removed or damaged, as will often be the case when they are exposed to frictional forces, for example by the action of wheel abrasion.

Accordingly, it is desirable to provide a retroreflective device which, when used in combination with a road marking paint or coating, will impart very good reflectivity characteristics and be durable under the action of traffic.

Previously, it has been proposed to provide a retroreflective device comprising an agglomerate of light-reflecting spheres joined together by an adhesive. Such a device represents a considerable improvement over the prior art discussed above, since it will consist of a multi-layer structure of light-reflecting spheres. Should the outer layer become removed or damaged a new layer of spheres will be exposed.

However, despite the apparent desirability of such a device, considerable problems have been experienced in trying to manufacture agglomerations of glass beads of consistent quality and size, and on a scale large enough to allow retroreflective devices to be produced on a commercial level.

One previously proposed method of manufacture involves the use of a spray device which sprays adhesive binder onto the surface of a moving, agitated bed of glass beads. A number of spray techniques have been proposed, such as air assisted atomisation, spinning disk (prilling) etc. However, any advantages associated with the production rate of this techniques are outweighed by the lack of precision that it affords. In particular, the quantity and size of binder droplets cannot be controlled to a sufficient degree, so that the resultant agglomerations of beads are of varying size. Furthermore, when spraying binder onto a bed of glass beads, some of the beads do not come into contact with the binder, whereas some beads are “double coated”. Thus, the quality and size of agglomerates produced by this method is inconsistent.

U.S. Pat. No. 3,254,563 discloses a method of forming reflective spheroids. Agitated hot glass spheres on a conveyor come into contact with droplets of a binder material. The heat from this contact lowers the viscosity of the binder sufficiently to allow the glass spheres to become embedded approximately halfway in the droplet. The droplet then cures to a solid sphericoid.

In U.S. Pat. No. 4,609,587 coated glass spheres are dispersed in wet paint just after paint is applied to a highway surface.

DE 1952 1847 discloses joining individual spheres by small drops of adhesive into a container holding small spheres with the size of the drops being adjustable by rapid lateral movement of the adhesive dispenser. An alternative disclosure is using an atomising gun to spray the adhesive sideways onto a layer of stationary or downwardly drizzling spheres.

U.S. Pat. No. 6,398,369 discloses elastomeric particles containing glass heads. The particles are formed in a mould.

In EP 0 322 671 a particle is coated in film with microspheres being dipped in a transparent binder to provide a cluster. The clusters are formed in a rotary mixer.

GB 2,164,762 disperses glass spheres contained in a softened steel from which granules are formed by passing the sheet through nip rollers, one of which has indentations in its surface to cut off the granules from the sheet.

U.S. Pat. No. 3,043,196 discloses beads being attached to tacky coated granules in a tumbler in a batch process.

U.S. Pat. No. 5,942,280 describes glass flakes being coated with a barrier layer. Then coated optical elements are mixed with the coated glass flakes prior to a heat treatment occurring to partially embed the optical elements into the core.

All of these methods are time consuming and produce inconsistent retroreflective devices.

It is therefore desirable to provide a method of manufacturing an agglomeration of glass beads which results in the production of agglomerations of consistent size and quality and which may be implemented on a sufficiently large scale.

According to one aspect of the present invention a method of manufacturing an agglomeration of retroreflected pieces includes forming a bed of the pieces, depositing a plurality of droplets of binder material from a plurality of spaced outlets of a droplet dispenser onto the bed of pieces thereby causing a plurality of the pieces to be held together in discrete agglomerations by each droplet, and causing relative movement in a first direction between the bed of pieces and the dispenser whereby droplets from each dispenser outlet are only applied at a discrete location onto the bed of beads.

The droplets from each dispenser may only be applied at a single discrete location, that is one droplet only at each location.

The method may comprise causing the discrete location of at least two dispensed droplets from the dispenser to be spaced from each other in a second direction transverse to the first direction. The method may comprise causing the discrete location of at least two droplets from the dispenser to be spaced from each other in the extent of the first direction. At least two outlets of the droplet dispenser may be arranged to be supplied with binder material from a common passage prior to the binder material in that common passage being divided into separate outlet passages for the outlets.

There may be a plurality of droplet dispensers each dispensing a plurality of droplets of binder material at discrete locations.

Each droplet dispenser may dispense a number of spaced droplets onto the bed of pieces. At least three dispensed droplets in adjacent rows may be deposited first upstream with respect to the first direction, secondly downstream and thirdly upstream. The first and third upstream locations may be arranged to be at different upstream locations with respect to the first direction. All droplets may be caused to be at different locations in the first direction in adjacent rows.

The method may comprise causing further retroreflected pieces to be deposited onto the bed of pieces after the depositing of the droplets thereby causing further pieces to be binded to the already bound pieces.

The method may comprise treating the binder material to harden the binder material.

The method may comprise forming the bed of pieces on a conveyor moving in the first direction.

The method may comprise causing at least two droplets to be dispensed simultaneously.

The method may comprise depositing the droplets on the dispenser by means of a plurality of a channels, each channel having substantially the same internal dimensions.

According to a further aspect of the present invention apparatus adapted to form an agglomeration of rectroreflected pieces includes a binder dispenser arranged, in use, to dispense the binder material from a plurality of spaced outlets onto a bed of pieces and movement means arranged, in use, to cause relative movement between the bed and the dispenser whereby droplets from each outlet are applied at a single discrete location onto the bed of pieces.

The apparatus may include a plurality of the dispenser outlets each arranged to be supplied by a separate channel. Each channel may have the same internal configuration along at least part and preferably the whole extent. The cross-sectional area of each separate channel may be constant along the length of each channel. A plurality of separate channels may be connected to a common inlet. The apparatus may include a plurality of dispensers each having a plurality of outlets and each being connected to a common inlet, each inlet being connected to a single binder distribution device.

Where retroreflective pieces are referred to herein it will be appreciated that they may comprise beads such as glass beads.

According to one aspect of a first aspect of the present invention there is provided a method of manufacturing an agglomeration of glass beads, wherein the method comprises: i) forming a bed of glass beads; ii) depositing droplets of a binder material onto the bed of glass beads by means of a plurality of channels, each channel being of substantially identical length and diameter.

Preferably, the agglomerates are highly reflective, strong, abrasion resistant and weather resistant. It is particularly preferable to achieve a drop yield whereby 90% of the drops have a size tolerance of at least .+−.2% by weight.

Preferably, each of the channels are in fluid communication with a single binder inlet.

Preferred methods include the step of applying a further layer of beads after deposition of the binder material, so as to form a substantially spheroid or ovoid agglomeration of glass beads.

The drops of binder material will diffuse into the glass beads such that as the binder material hardens, or is cured by the application of heat or UV radiation, groups of the glass beads will bind together. A curing oven may be provided which applies heat to cure the binder compound or can otherwise be used to cure by UV radiation or any other radiation for a suitable binder activated by radiation other than UV.

Preferably, the bed of glass beads is moved from a first position at which the binder material is deposited to a second position at which the agglomerations of glass beads are removed from the bed, preferably by means of separation techniques, and any loosed beads are returned to the first position.

The glass beads are preferably approximately spherical and have a diameter preferably selected to be within one of the following ranges: from 100 microns to 300 microns, from 200 microns to 400 microns, or from 400 microns to 700 microns. Larger beads may be used to form agglomerations, but the ranges specified are preferred sizes for the application.

The bed of beads may be of any depth but is preferably not less than 10 mm deep. Advantageously, selected properties of each glass bead, for example its refractive index, may be chosen in accordance with the desired retroreflectivity of the device. Furthermore, the size of each glass bead may be selected.

Desirably, the binder material, which may consist of more than one component, comprises an adhesive material, for example epoxy resin, acrylic, polyurethane or a hot melt adhesive, or any other suitable adhesive such as polyureides or polyesters. Furthermore, numerous blends or combinations of these adhesives are envisaged.

The adhesive material may be pigmented, thereby to colour retroreflected light from the device. The adhesive material may include a metallic pigment which may be a coloured pigment. Preferably, each of the components of the binder material are separately deaerated and conditioned in a low pressure chamber prior to being supplied to the dispensing device. Furthermore, they are preferably mixed to a homogeneous consistency before being supplied, under pressure, to the dispensing device. This may be achieved by means of a dynamic mixing blade running at speeds of between 100 rpm to 5000 rpm. Binder components may be separately transferred from a low pressure chamber to a mixing device via pumps and pneumatically controlled dispensing valves which accurately inject predetermined amounts of material. A particular advantage of preferred embodiments of the present invention is the ability to mix liquid components of differing viscosities.

The size of the binder droplet, physical properties of the binder material (particularly its viscosity and cure rate) and the size/gradation of the glass beads are key factors which determined the quality of the agglomeration of beads produced.

The channels may be disposed such that the paths of the binder droplets do not overlap.

According to an embodiment of a second aspect of the present invention, there is provided an apparatus for manufacturing an agglomeration of glass beads comprising a plurality of glass beads and a binder material, the apparatus comprising at least one binder dispensing device, wherein the or each dispensing device comprises a plurality of channels along which, in use, the binder material flows, each channel terminating in an outlet and being in fluid communication with a single binder inlet, and wherein the channels are of substantially identical length and diameter.

According to a particularly preferred embodiment, the apparatus comprises three binder dispensing devices and binder material is supplied to each of the binder inlets from a single distribution device. The distribution device preferably comprises a distributor inlet and three distributor channels, each of the distributor channels being of substantially identical length and diameter and each distributor channel terminating at one of the binder inlets.

The use of a binder dispensing device embodying the present invention exhibits a number of advantages. Importantly, the binder dispensing device allows a plurality of drops of a binder material to be dropped onto the bed of glass beads at different positions substantially simultaneously, thereby significantly increasing the production rate of agglomerates as compared to the methods known from the prior art. Indeed, embodiments of the present invention will allow the mass production of agglomerates of glass beads.

Furthermore, the provision of a plurality of channels, each of substantially identical length and diameter, ensures that the size of the droplets from each of the channels are substantially identical In addition, the binder dispensing device allows the flow of binder in each of the plurality of channels to be controlled by adjusting the quantity of binder applied to a single binder inlet. Thus, agglomerates manufactured according to preferred methods of the present invention are advantageously of a consistent size and quality.

Furthermore, the rate of discharge of binder material from the channel outlets can be controlled by adjusting the pressure applied to the single inlet, and will be substantially the same from each outlet. This enables the optimum drop rate to be selected according to the chosen speed of movement of the glass bead.

The rate of discharge may typically range from 5 to 100 milligrammes per second per nozzle outlet and the channels may typically range from 15 to 20 mm long. However, the length of the channels are not critical provided that the channels (and nozzle outlet) are all of substantially equal diameter and length—so as to balance the internal pressures and flow rates. Depending on the desired droplet size, the channel diameters may range from 0.1 or 0.3 mm to 5 mm, or an equivalent cross-sectional area of any configuration other than a diameter such as a semi-circle, and generally the channel diameter should match the nozzle outlet diameter.

According to an embodiment of a third aspect of the present invention, there is provided an agglomeration of glass beads manufactured according to a method embodying the first aspect of the present invention.

According to an embodiment of a fourth aspect of the present invention, there is provided a retroreflective device comprising an agglomeration of glass beads manufactured according to a method embodying the first aspect of the present invention.

According to an embodiment of a fifth aspect of the present invention, there is provided a retroreflective device for use in creating a retroreflective surface, which device comprises an agglomeration of glass beads manufactured according to a method embodying the first aspect of the present invention.

Retroreflective devices comprising agglomerates of glass beads manufactured in accordance with preferred embodiments of the present invention can advantageously be used to enhance the reflectivity of road surfacing materials and road markings, including coloured road surfacing, traffic claming surfaces, etc.

According to an embodiment of the present invention there is provided the use of a plurality of retroreflective devices, comprising agglomerates of glass beads manufactured according to methods embodying the present invention, in combination with road marking material as a retroreflective road marking coating or road surfacing material.

According to an embodiment of the present invention there is provided the use of a plurality of retroreflective devices comprising agglomerates of glass beads manufactured according to methods embodying the present invention, in combination with a binder material as a retroreflective surface dressing.

According to an embodiment of the present invention there is provided a retroreflective road marking coating comprising a road marking material applied to the surface of a road and a plurality of retroreflective devices, manufactured according to an embodiment of the first aspect of the present invention, embedded in the road marking material so as to protrude partially therefrom. The retroreflective devices may be premixed or otherwise immersed in the road marking material.

According to an embodiment of the present invention there is provided a retroreflective surface dressing comprising a binder material coating the surface to be dressed and a plurality of retroreflective devices, manufactured according to an embodiment of the first aspect of the present invention, adhering to the binder material so as to protrude partially thereform.

Embedment of glass beads in a pigmented adhesive or binder is known to give a reflected colour depending on the type and properties of the pigment and binder/adhesive used. However, agglomerates of glass beads manufactured in accordance with preferred embodiments of the present invention, and which comprise pigmented adhesive or binder, have been found to exhibit far superior reflectance of colour when compared to know products. Indeed, the use of glass beads of a specific quality/refractive index and a predetermined uniform size, enables a reflective device to be produced which has a high density of glass spheres on the surface which are in contact with a large surface area of colour. This achieves far superior colour density and intensity of reflected light and is demonstrably better than known products comprising ordinary glass beads embedded in a coloured binder. This superior colour reflectance is also a result of the highly reflective properties of the agglomerate which is a result, not only of using high quality glass beads, but also of its closely packed construction, i.e. the glass beads are bound together in very close proximity. In addition to close packing of glass beads throughout the body of the agglomerate, the glass beads on the surface of the bead cluster are also close packed thereby achieving optimum reflective performance and resistance to traffic and/or weathering.

The glass beads are preferably spherical and formed of good quality clear glass substantially free from faults and inclusions. They preferably exhibit a refractive index of 1.5, 1.9 or 2.1.

Any of the methods referred to herein may be combined and any of the features referred to may be substituted for any of the other features.

For a better understanding of the present invention and to show how the same may be carried into effect, reference will now be made, by way of example, to the accompanying drawings in which:

### BRIEF DESCRIPTION OF THE DRAWINGS

FIG. 1 shows an apparatus for manufacturing an agglomeration of glass beads embodying the present invention;

FIG. 2 shows a dispensing device for use with an apparatus embodying the present invention;

FIG. 3 shows a schematic illustration of a method of manufacturing an agglomeration of glass beads embodying the present invention; and

FIG. 4 shows a retroreflective device manufactured in accordance with methods embodying the present invention.

### DETAILED DESCRIPTION OF THE INVENTION

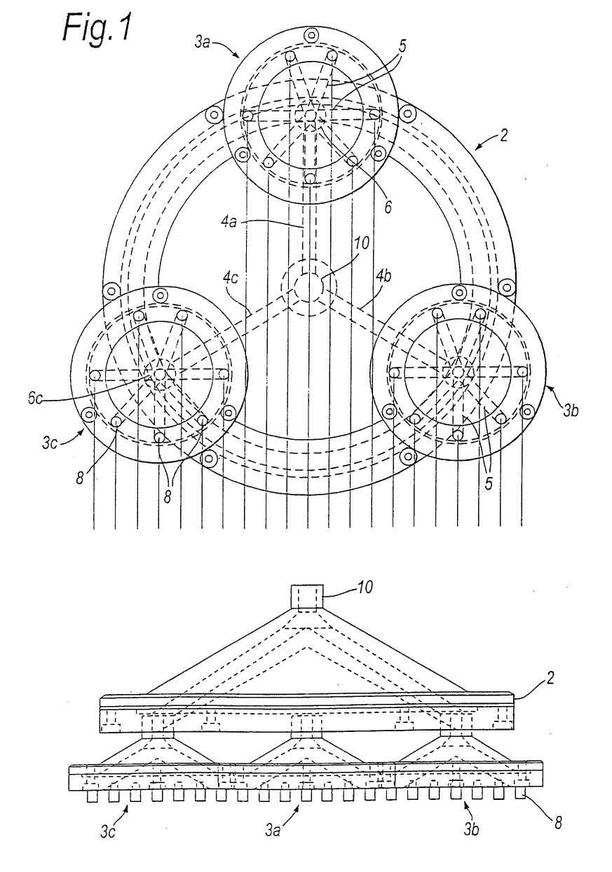

FIG. 1 shows an apparatus for manufacturing an agglomeration of glass beads embodying the present invention comprising: a distribution device 2, having a distribution inlet 10, coupled to three binder dispensing devices 3a, 3b and 3c by means of distributor channels 4a, 4b and 4c of substantially identical length and diameter. Each of the distribution devices comprises seven dispenser channels 5 of substantially identical length and diameter and being connected to a binder inlet 6. The channels each terminate in an outlet 8.

In use, a predetermined quantity of binder material, which may comprise a homogeneous mix of two or more components, is supplied by means of pumps to the distribution inlet 10 under pressure. The speed of the pumps and the pressure can be controlled so that, in combination with the distribution channels 4a, 4b and 4c and the dispenser channels 5, drops of a precisely defined size are produced at a controlled rate of discharge. The paths of the droplets of binder material have been traced by lines 9 for illustrative purposes. It can be seen that the positions of the outlets have been chosen relative to each other so as to ensure that he paths of the drops do not overlap. In this way, when using the apparatus in accordance with method embodying the present invention, the drops may be deposited onto a moving bed of glass beads without double coating any areas of the bed.

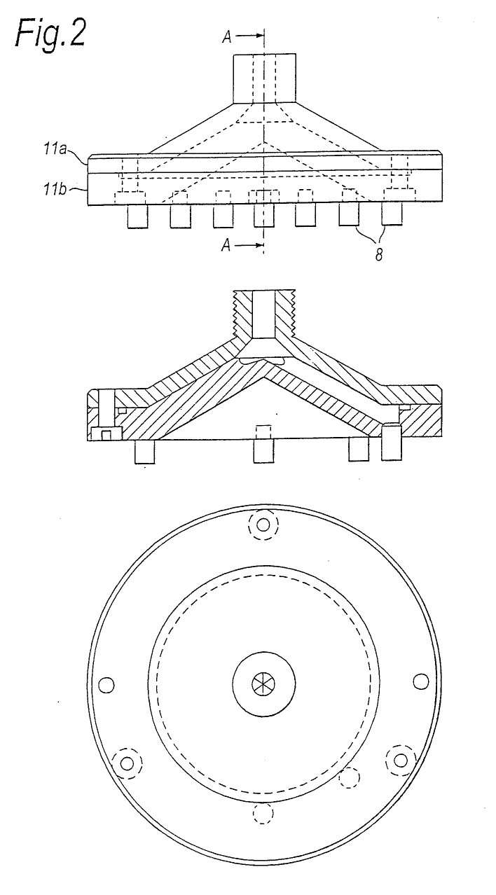

FIG. 2 shows, in more detail, the dispensing device 3a as shown in FIG. 1. The outlet nozzles 8 are screw fitted to the dispensing device 3a which is itself screwed to the distribution device 2. The dispensing device 3a consists of an upper and a lower casing, 11a and 11b respectively, which is bolted together. In this embodiment, the dispensing device is usefully designed so that the upper and lower casing can be easily separated for cleaning and maintenance. The nozzles are arranged such that the distance between the central axes of adjacent nozzles, shown by x in FIG. 2, is 9 mm.

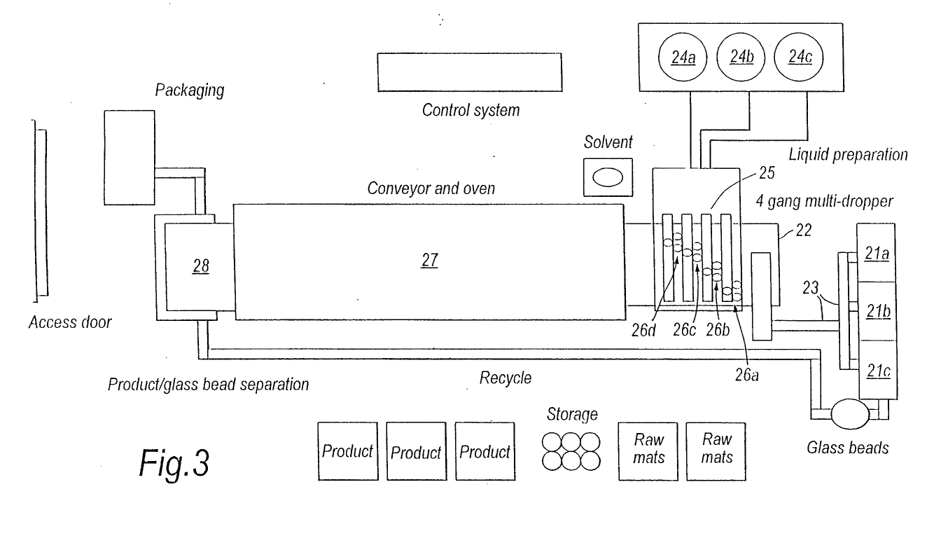

FIG. 3 shows a schematic illustration of a method of manufacturing an agglomeration of glass beads embodying the present invention. Glass beads are stored in containers 21a, 21b and 21c according to their size/refractive index and may be transported to a moving bed 22 by means of a conveyor system 23. The binder components are separately deaerated and conditioned in low-pressure chambers 24a, 24b and 24c and are transferred to a mixing device before being supplied to a distribution unit 25. The distribution unit comprises 4 distribution devices 26a-d, each having three binder dispensing devices. The positions of the outlets have been chosen relative to each other so as to ensure that the paths of the drops do not overlap.

The rate of discharge of the binder droplets is controlled in accordance with the speed of the moving bed of glass beads.

The binder coated beads are passed into a curing oven 27 so as to shorten the time it takes for the binder to harden and for agglomerates of glass beads to be formed. Although not specifically illustrated, a means for depositing a second layer of beads, after the binder deposition has taken place and before the moving bed enters the oven, may be provided in accordance with preferred embodiments of the present invention. The agglomerates and uncoated glass beads are then separated in a separation unit 28 and any loose glass beads are recycled. The time between application of the binder and the collection and separation process needs to be controlled to enable setting/curing of the binder 3 to a sufficient degree to allow handling of the product without damage or disruption to the agglomeration of beads.

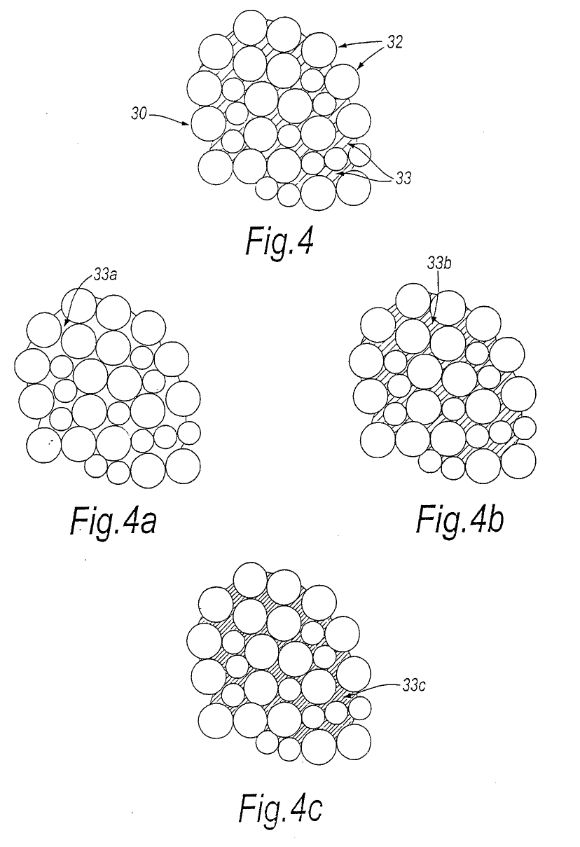

As shown in FIG. 4, a retroreflective device 30, produced by methods embodying the present invention, is manufactured by binding a quantity of spherical glass beads 32 of a desired size with an adhesive 33 so as to form a spherical or ovoid agglomeration or cluster 30, preferably 2 to 4 mm in diameter (although other sizes may be useful according to the application). The size of the glass beads 32 is preferably selected to be within one of the following ranges, from 100 microns to 300 microns, from 200 microns to 400 microns, or from 400 microns to 700 microns, although larger beads may also be used to form agglomerations where appropriate. In this example, two different sizes of glass beads are used, however, in many instances it will be preferably to use glass beads of a single uniform size. The adhesive 33 may, for example, be epoxy resin, acrylic, polyurethane or hot melt adhesive. The cluster 30 of beads 32 so formed has retroreflective properties as its surface is made up of a number of glass spheres in close packed formation throughout the cluster presenting a large number of reflecting elements. Light entering a bead 32 is reflected internally and re-emitted in the direction of the source. The light returning to the source (e.g. the vehicle) can be modified in colour by using a pigmented adhesive 33a, 33b or 33c to bind the beads 2, as shown in FIGS. 4A to 4C. The pigmented adhesive 33a, 33b, 33c forms a coloured backing to the glass beads 32. Light entering the glass beads 32 is subject to internal reflection and allows some diffusion into the pigmented adhesive 33a, 33b, 33c. By this means the light colour is modified by the effect of the pigmented adhesive 33a, 33b, 33c and is thus modified before it returns in the direction of the source. The adhesive material 33 may be pigmented with white, red, yellow, green, or indeed any strong colour, to produce a reflected colour as required. Alternatively, the glass may itself be coloured to modify the light, either by the chemical composition of the glass or by a suitable coating treatment. By this means the bead clusters 30 may be used in road markings and other road surfacing to produce a coloured appearance as an aid to driver safety and to provide information about road layout and possibly hazardous situations.

The properties of the glass used to make the beads 32, such as its chemical formulation, may be varied to achieve a greater degree of reflectivity. In particular, glass of different refractive index, for example values of 1.5, 1.9 and 2.1, may be used, since glass beads 32 manufactured from higher refractive index glasses return more light and therefore improve the retroreflective performance. Additionally, a mixture of glass beads of different refractive indices may be used.

In order to obtain a retroreflective surface, a plurality of retroreflective devices are applied to the still liquid or semi-liquid surface of a road marking material painted onto a road and become embedded in the surface so that they are anchored in the surface with a portion of each retroreflective device 30 protruding above the surface of the marking, such that the exposed part of the bead clusters 30 can become illuminated with light from head lamps of vehicles and reflect light back to the driver. The bead clusters 30 embedded into the surface are firmly held by the road marking material, the surface structure of each cluster 30 being textured by the presence of glass beads 32 so that the road marking material is absorbed into the textured surface of the cluster 30, this keying effect increasing retention and strength of adhesion of the bead cluster 30.

As mentioned above, the size of the cluster 30 is usefully in the range from 2 mm to 4 mm diameter; however, larger or smaller clusters 30 may be used in accordance with the thickness of the coating for which they are intended and the degree of embedment. Thus a road marking paint line nominally 500 .mu.m in thickness could use clusters 30 in the size range 1 mm to 2 mm diameter, whereas a thicker line such as a thermoplastic road marking nominally 3 mm in depth would require clusters 30 of 4 mm to 6 mm diameter to be effective.

An alternative use of the retroreflective devices 30 would be in a road surface dressing, coloured road surfaces for hazard warning, or on vertical surfaces, for example safety barriers, road signs (vertical), etc. These applications would require a relatively low thickness of binder material to allow a large exposed area of reflective material. Such usage requires a particularly strong and durable binder to hold the clusters 30 to the substrate, for example (but no exclusively) two component materials epoxy resin, acrylic and polyurethane.

Unlike prior art road markings whose reflectivity is provided by individual glass beads and which therefore lose reflectivity as the beads become damaged or are dislodged from the surface due to the action of traffic, retroreflective devices 30 manufactured according to present techniques comprise an agglomeration of glass beads 32 having a multilayer structure which enables continuity of reflectivity by exposing a new, inner layer of glass beads 32 after the original outer layer of beads 32 has been removed, for example by the action of road traffic.

Rather than being applied on a surface, the retroreflective devices 30 can also be advantageously used a premixed additives to a road marking material, in a quantity proportional to the thickness of the coating to be applied, the devices becoming exposed as the road marking material wears away.

Thus, retroreflective devices manufactured by method embodying the present invention have a retroreflectivity performance providing efficient retroreflection of incident light. When used in road marking or surfacing materials to increase visibility in low light or nigh-time conditions the devices have higher durability under traffic than the individual glass beads used in the prior art, owing to the multi-layering of glass beads in the cluster and the keying effect of the surface characteristics of the cluster 1. Larger bead clusters are likely to give extra visibility performance in so-called “wet night conditions”, because the clusters stand proud of the road marking line and are more visible when there is water on the road.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A method of manufacturing an agglomeration of retroreflective pieces including:
forming a bed of the pieces;
depositing a plurality of droplets of binder material from a plurality of spaced outlets of a droplet dispenser onto the bed of pieces thereby causing a plurality of the pieces to be held together in discrete agglomerations by each droplet, and
causing relative movement in a first direction between the bed of pieces and the dispenser whereby droplets from each dispenser outlet are only applied at a discrete location onto the bed of beads, and
causing further retroreflective pieces to be deposited onto the bed of pieces after the depositing of the droplets thereby causing further pieces to be bound to the already bound pieces.

2. A method as claimed in claim 1 in which only one droplet is deposited at each discrete location.

3. A method as claimed in claim 1, comprising causing a discrete location of at least two droplets of binder material dispensed from the plurality of outlets to be spaced from each other in a second direction transverse to the first direction.

4. A method as claimed in claim 1 comprising causing the discrete location of at least two droplets of binder material from the plurality of droplets to be spaced apart from one another along the first direction.

5. A method as claimed in claim 3 in which at least two outlets of the droplet dispenser are arranged to be supplied with binder material from a common passage prior to the binder material in that common passage being divided into separate outlet passages for the outlets.

6. A method as claimed in claim 1 including a plurality of droplet dispensers each dispensing a plurality of droplets of binder material at discrete locations.

7. A method as claimed in claim 6 in which each droplet dispenser dispenses a number of spaced droplets onto the bed of pieces.

8. A method as claimed in claim 1 comprising forming the bed of pieces on a conveyor moving in the first direction.

9. An agglomeration of retroreflective pieces manufactured according to the method claimed in claim 1.

10. A retroreflective road marking coating comprising a road marking material applied to the surface of a road and a plurality of retroreflective agglomerations of pieces as claimed in claim 19 embedded in the road marking material so as to protrude partially therefrom.

11. A method as claimed in claim 7 wherein the depositing of droplets of binder material is carried out by dispensing a first droplet of binder material in a first discrete location, a second droplet in a second discrete location displaced from the first location and opposite the first direction, and a third droplet in a third discrete location displaced from the second location in the first direction.

12. A method as in claim 11 wherein the depositing of droplets of binder material is carried out such that the first and second discrete locations are spaced apart from one another along the first direction, the second and third locations are spaced apart from one another opposite the first direction, and the first and third locations are spaced apart from one another in at an angle relative to the first direction.

13. A method as in claim 11 wherein the depositing of binder material is carried out such that the discrete location of the first and second droplets of binder material are transversely spaced apart from one another relative the first direction.

14. A method of manufacturing an agglomeration of retroflective pieces comprising:
providing a plurality of beads in a storage container;
transferring at least some of the plurality of beads to a bed;
de-aerating at least one component used for making binder material in a low pressure chamber;
transferring the at least one component from the low pressure chamber to a mixing device;
mixing a plurality of components to form a substantially homogeneous mixture of binder material;
supplying the binder material under pressure to a distribution unit having a plurality of dispensing devices;
depositing a plurality of droplets of binder material from a plurality of spaced outlets of the dispensing devices onto the bed thereby causing adjacent beads of the plurality of the beads to be held together in discrete agglomerations around each droplet;
causing relative movement in a first direction between the bed and the dispensing devices whereby the droplets dispensed from the outlets of each dispending device are applied to discrete locations on the bed containing the plurality of beads;
causing further beads to be deposited onto the bed after the droplets are deposited onto the bed, thereby causing further beads to be bound to the agglomerations;
curing the agglomerations, thereby causing the droplets of binder material to harden around beads that are bound together;
separating the agglomerations from beads that have not formed agglomerations; and
causing the beads that have not formed agglomerations to be returned to an area where they have another opportunity to be introduced to additional binder material deposited from the outlets of the dispending devices.

15. The method of claim 14 whereby the curing is accomplished by applying heat to the agglomerations.

16. The method of claim 14 whereby the curing is accomplished by exposing the agglomerations to UV radiation.

17. The method of claim 14 further comprising separating the plurality of beads based on their size into a plurality of separate storage containers, thereby causing each of the plurality of storage containers to house beads of a substantially equal size.

18. The method of claim 14 whereby the transferring of at least one component from the low pressure chamber to a mixing device is accomplished by pumps and pneumatically controlled dispensing valves.

19. The method of claim 14 comprising forming the bed on a conveyor moving in the first direction.

20. The method of claim 14 comprising causing a discrete location of at least two droplets of binder material dispensed from the plurality of outlets to be spaced from each other in a second direction transverse to the first direction.

21. The method of claim 14 whereby the plurality of spaced outlet each dispense a plurality of droplets of binder material at discrete locations along the bed.

22. The method of claim 21 in which each outlet dispenses a number of spaced droplets onto the bed of pieces.

23. The method of claim 22 wherein the depositing of droplets of binder material is carried out by dispensing a first droplet of binder material in a first discrete location, a second droplet in a second discrete location displaced from the first location and opposite the first direction, and a third droplet in a third discrete location displaced from the second location in the first direction.

24. The method of claim 23 wherein the depositing of droplets of binder material is carried out such that the first and second discrete locations are spaced apart from one another along the first direction, the second and third locations are spaced apart from one another opposite the first direction, and the first and third locations are spaced apart from one another in at an angle relative to the first direction.
